(19) United States
(12) Patent Application Publication
(10) Pub. No.: US 2008/0101853 A1
(43) Pub. Date: May 1, 2008

(54) Synchronously Adjustable Pivot

(76) Inventor: Shian-Nung Huang, Tucheng City (TW)

Correspondence Address: HDSL, 4331 STEVENS BATTLE LANE, FAIRFAX, VA, 22033, US

(21) Appl. No.: 11/553,997

(22) Filed: Oct. 28, 2006

(51) Int. Cl. F16C 11/00

(52) U.S. Cl. 403/92

(57) ABSTRACT

A synchronously adjustable pivot has a function of balancing the torque and is provided between an outer receiving seat and an inner receiving seat. The pivot further includes an outer sleeve. One end of the outer sleeve is provided with a knob and an inner sleeve threadedly connected to the knob. Further, the other end of the outer sleeve is provided with a bolt. Elastic elements are provided at the outside of both ends of the outer sleeve. When the pivot provided with elastic elements is arranged into the inner receiving seat, a washer having high coefficient of friction is disposed between the outer receiving seat and the inner receiving seat. Finally, a bolt is used for fixation. With the above arrangement, when the degree of tightness between the outer receiving seat and the inner receiving seat is enhanced via the pivot, the large friction generated by the washer is used to balance the rotating torque on both ends of the pivot and keep the degree of tightness on both ends thereof equal.

### BACKGROUND OF THE INVENTION

1. Field of the Invention

The present invention relates to a pivot, and in particular to a pivot for synchronously adjusting the tightness of both ends thereof by means of friction.

2. Description of Prior Art

Among the existing structure having a function of adjusting angles, such as a support for a computer screen or thinned television, or electric appliances such as an electric fan, mostly, a pivot is used to control the degree of tightness between the supporting article and the article to be supported. In this way, when the angle of the support is adjusted, with the action of the pivot, a sufficient supporting force can be generated to support the angle formed between both ends thereof.

In terms of a conventional structure, the pivot utilizes a plurality of corresponding frictional faces, and locking means is designed on the frictional faces. With the corresponding frictional faces and the locking means, the relative position between the supporting article connected thereto and the article to be supported can be adjusted. Further, the degree of tightness between the supporting article connected thereto and the article to be supported can be varied to timely provide a desired supporting force.

However, in the conventional pivot, since the positions of the frictional faces on both ends thereof should be simultaneously adjusted, the applied forces are often uneven. Therefore, it is not easy to simultaneously adjust the locking positions of both ends, so that both ends are subjected to unequal forces. Moreover, the locking means on the frictional faces is easily worn to lose the original tightness and supporting effect.

Therefore, another kind of pivot is developed in prior art, in which the pivot is provided with a sleeve and a bolt that are threadedly connected to each other. The movement of the bolt within the sleeve can provide the tightness for the pivot. Such a structure not only avoids from simultaneously adjusting both ends of the pivot, but also overcomes the wear of the locking means in prior art by means of the rotation of the bolt.

Although the above structure can overcome some drawbacks of prior art and provide a sufficient supporting force to fix the relative position between the supporting article and the article to be supported, the bolt concentrates on one end of the pivot to produce the tightness, making the relative torques generated in adjusting both ends of the pivot to become asymmetrical. Accordingly, a phenomenon that one end is loose but the other end is tight may occur, making the relative position between the supporting article and the article to be supported to become inclined.

### SUMMARY OF THE INVENTION

The present invention is to provide a synchronously adjustable pivot having a function of balancing the frictional torques on both ends, which lies in that one end of the pivot for rotating a knob is provided with a set of washers having high coefficient of friction. When a user intends to adjust the pivot, with the large friction of the set of washers, the relative torques on both ends can be balanced, and thus the pivot can rotate with the same degree of tightness.

The present invention is to provide a synchronously adjustable pivot provided between an outer receiving seat and an inner receiving seat. The pivot further comprises an outer sleeve. One end of the outer sleeve is provided with a knob and an inner sleeve threadedly connected to the knob. Further, the other end of the outer sleeve is provided with a bolt. Elastic elements are provided at the outside of both ends of the outer sleeve. When the pivot provided with elastic elements is disposed into the inner receiving seat, a washer having high coefficient of friction is disposed between the outer receiving seat and the inner receiving seat. Finally, a bolt is used for fixation, thereby to balance the rotating torque of the pivot and keep the degree of tightness on both ends thereof equal.

### BRIEF DESCRIPTION OF THE DRAWINGS

FIG. 1 is an exploded perspective view of the present invention;

FIG. 2 is an assembled perspective view of the present invention;

FIG. 3 is a cross-sectional view showing the operation of the present invention;

FIG. 4 is an assembled view showing an embodiment of the present invention;

FIG. 5 is a side view (I) showing the operation of the present invention;

FIG. 6 is a side view (II) showing the operation of the present invention; and

FIG. 7 is a side view (III) showing the operation of the present invention.

### DETAILED DESCRIPTION OF THE INVENTION

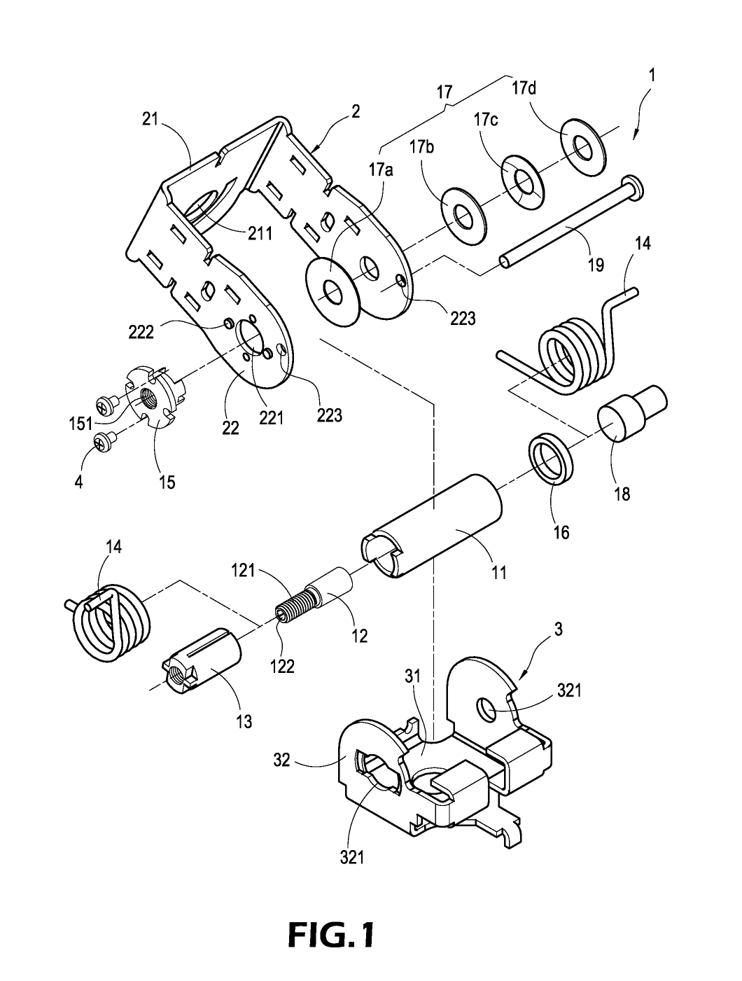

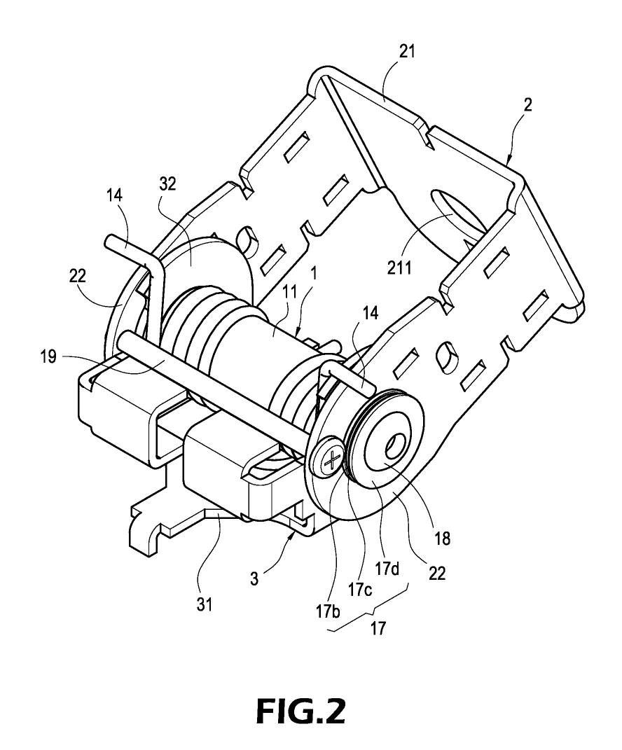

With reference to FIG. 1 and FIG. 2, they are an exploded perspective view and an assembled view of the present invention, respectively. As shown in the figures, the pivot 1 of the present invention is arranged between an outer receiving seat 2 and an inner receiving seat 3. Each profile of the outer receiving seat 2 and the inner receiving seat 3 is formed into a U-shaped body. The outer receiving seat 2 has a bottom plate 21. The bottom plate 21 has a through hole 211 thereon. Further, side plates 22 extend outwardly from both ends of the bottom plate 21. Each side plate 22 is provided with a through trough 221 thereon to correspond to the position of the pivotal center. Further, the periphery of one of the through troughs 221 is provided with a plurality of fixing holes 222. The edge of each side plate 22 is provided with a corresponding through hole 223. Further, the inner receiving seat 3 has a base 31 provided with a plurality of corresponding protruding plates 32. The surface of each protruding plate 32 is provided with a fixing trough 321 to correspond to the position of the pivotal center. One fixing trough 321 is slightly larger than the other fixing trough. In addition, both side plates 22 of the outer receiving seat 2 are provided at the outside of the two protruding plates 32 of the inner receiving seat 2.

The pivot 1 mainly comprises an outer sleeve 11. The interior of the outer sleeve 11 is hollowed. The interior of the outer sleeve 11 is accommodated with a knob 12 and an inner sleeve 13. One end of the knob 12 has a screw rod 121 having threads thereon. Further, the end face of the screw rod 121 has a locking hole 122 formed into a hexagon. The interior of the inner sleeve 13 also has threads for threadedly connecting with the screw rod 121 of the knob 12. The inner thread of the inner sleeve 13 on its inner wall is gradually converged toward the outside to form into a conical shape. Further, the outer surfaces of both ends of the outer sleeve 11 are provided with an elastic element 14, respectively. When the assembly of the above elements is completed, firstly, both ends of the outer sleeve 11 associated with the knob 12, the inner sleeve 13 and the elastic elements 14 are arranged to correspond to the positions of the fixing trough 321 of the inner receiving seat 3 and the through trough 221 of the outer receiving seat 2, respectively. One end face of the outer sleeve 11 is connected to a fixing seat 15 penetrating through the fixing trough 321 and the through trough 221. Further, a plurality of locking elements 4 is used to fix the fixing seat 15 at the outer receiving seat 2. The axial center of the fixing seat 15 has a through hole 151. The interior of the through hole 151 has threads. The through hole 151 exactly faces the locking hole 122 of the knob 12, so that a locking tool (not shown) can penetrate through the locking hole 122 via the through hole 151. A gasket 16 having the same radius as that of the outer sleeve is connected between the other end of the outer sleeve 11 and the protruding plate 32 of the inner receiving seat 3. Both ends of the side plate 22 of the outer receiving seat 2 are provided with a plurality of washers 17a-17d. The washer 17a is sandwiched between the side plate 22 of the outer receiving seat 2 and the protruding plate 32 of the inner receiving seat 3. The washer 17a is made of a material having high coefficient of friction. The washer 17c is curved and made of a material having high coefficient of friction. The washer 17c is sandwiched between another two washers 17b and 17d. Finally, the outer sleeve 11 is connected with a bolt 18 penetrating the fixing trough 321 and the through trough 221. Further, the plurality of washers 17b-17d is simultaneously sandwiched in the outside of the side plate 22 of the outer receiving seat 2. Further, an elongated fixing bolt 19 penetrates into the corresponding through holes 223 of the outer receiving seat 2, thereby to fix the relative position of both side plates 22 of the outer receiving seat 2.

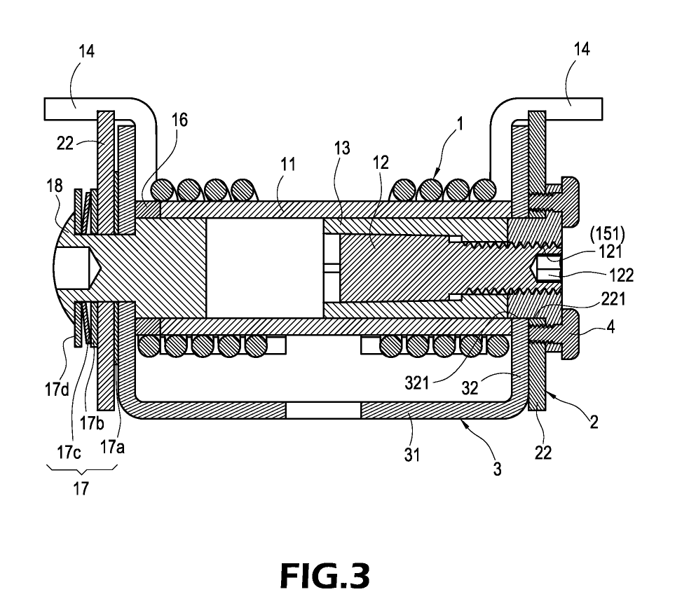

With reference to FIG. 3, it is a cross-sectional view showing the operation of the present invention. It can be seen that if the degree of tightness between the outer receiving seat 2 and the inner receiving seat 3 is to be adjusted, a locking tool (not shown) can be used to connect to the locking hole 122 of the knob 12 via the through hole 151 of the fixing seat 15. With this arrangement, the knob 12 can be rotated to move forwardly or backwardly. The action of the knob 12 makes the knob 12 to gradually engage with the inner threads of the inner sleeve 13, and thus the inner sleeve expands outwardly to generate a pressure. Finally, the inner sleeve expands to abut the side plate 22 of the outer receiving seat 2 and the projecting plate 32 of the inner receiving seat 3, so that an abutting and forcing action can be generated between the side plate 22 and the protruding plate 32. At the same time, when rotating the knob 12, since the washer 17a having high coefficient of friction is provided between the outer receiving seat 2 and the inner receiving seat 3, the friction of the washer 17a is used to generate an abutting and forcing action between the side plate 22 and the protruding plate 32. Further, with the aid of the elastic washer 17c provided at the outside of the side plate 22 of the outer receiving seat 2, the rotating torque of both ends of the pivot 1 can be adjusted to obtain balanced and equal forces on both ends.

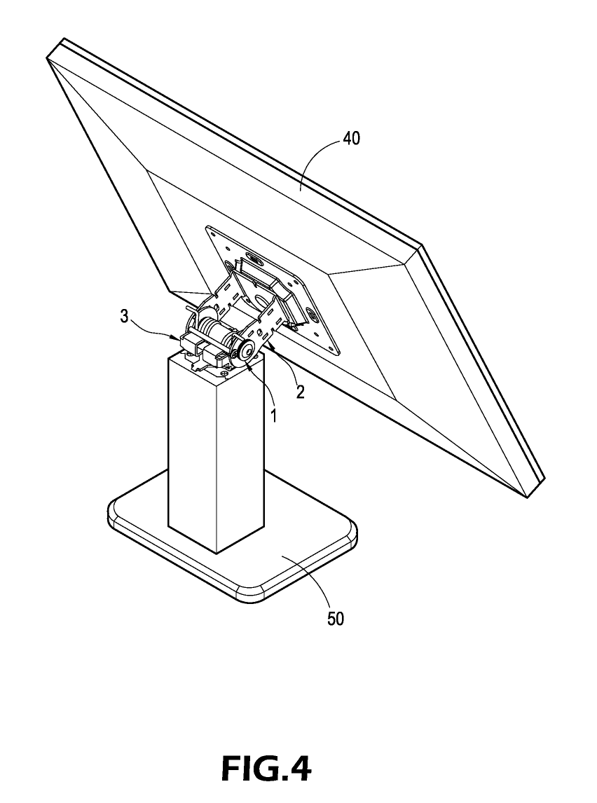

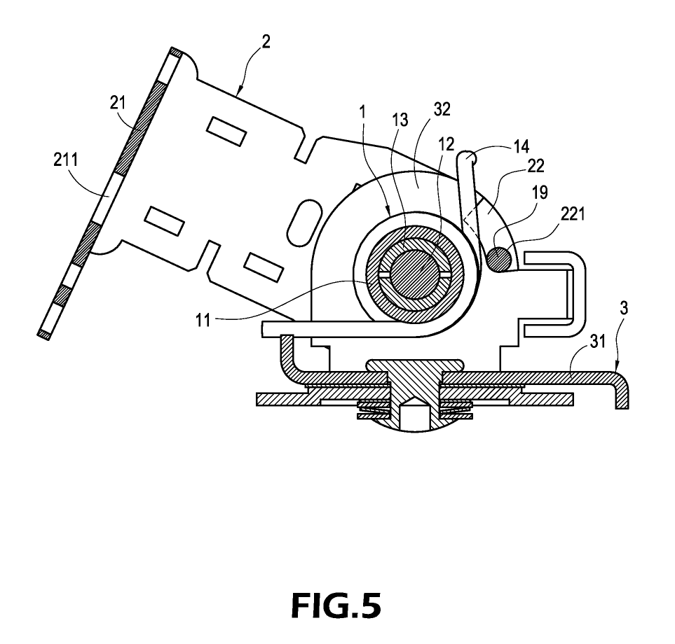

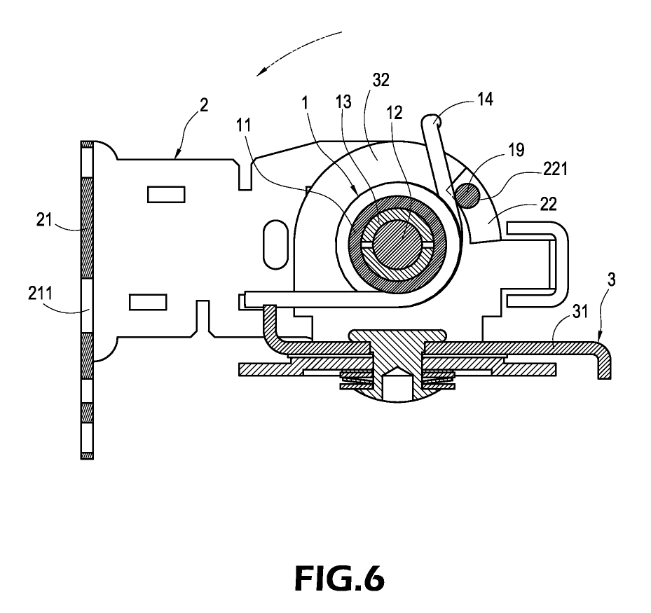

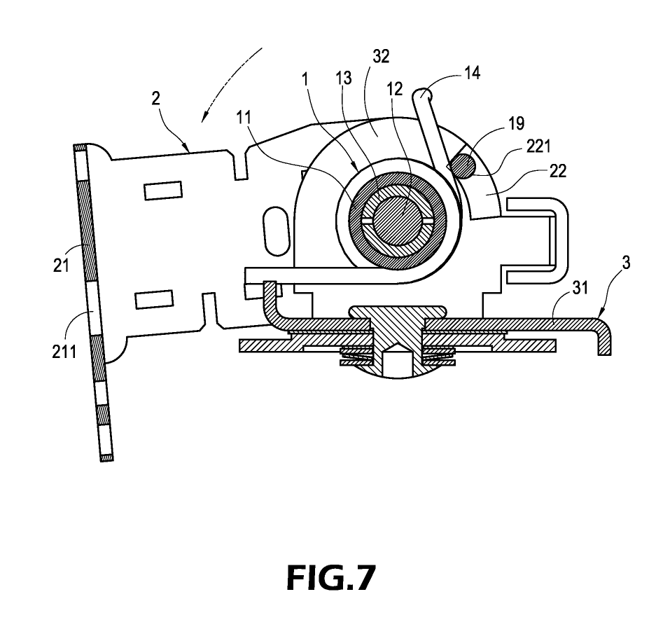

With reference to FIGS. 4 to 7, they are an assembled view of an embodiment of the present invention and side views showing the sequential operations of the present invention, respectively. The outer receiving seat 2 is connected to a screen 40. The inner receiving seat 3 is connected to a support 50. The adjustment of the degree of tightness of the pivot can not only easily change the angle between the outer receiving seat 2 and the inner receiving seat 3, but also generate a supporting force sufficient for changing the relative position between the different angles of the outer receiving seat 2 and the inner receiving seat 3. When the pivot 1 is adjusted, the phenomenon that the torques on both ends are different to make the position between the outer receiving seat 2 and the inner receiving seat 3 is inclined can be avoided.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A synchronously adjustable pivot connected between an inner receiving seat and an outer receiving seat, comprising:
an outer sleeve with its interior hollowed;
a knob accommodated in the outer sleeve, one end thereof having a screw rod;
an inner sleeve accommodated in the outer sleeve, the inner sleeve being hollow and an inner surface thereof having threads for threadedly connecting to the screw rod;
a fixing seat provided at the outside of one end of the outer receiving seat, penetrating through the outer receiving seat and the inner receiving seat and connected with one end of the outer sleeve, the axial center of the fixing seat provided with a through hole for facing the screw rod of the knob;
a bolt provided at the outside of the other end of the outer receiving seat, penetrating the outer receiving seat and the inner receiving seat and connected with the other end of the outer sleeve; and
a plurality of washers sandwiched between the inner receiving seat and the bolt.

2. The synchronously adjustable pivot according to claim 1, wherein the outer peripheral faces on both ends of the outer sleeve is further provided with elastic elements.

3. The synchronously adjustable pivot according to claim 1, wherein the end face of the screw rod further has a locking hole.

4. The synchronously adjustable pivot according to claim 3, wherein the locking hole is formed into a hexagon.

5. The synchronously adjustable pivot according to claim 1, wherein the inner receiving seat has protruding plates, the outer receiving seat has side plates, one of the washers is sandwiched between the protruding plate of the inner receiving seat and the side plate of the outer receiving seat.

6. The synchronously adjustable pivot according to claim 5, wherein the washer is made of a material having high coefficient of friction.

7. The synchronously adjustable pivot according to claim 1, wherein the outer receiving seat has side plates, and the plurality of washers is sandwiched between the side plate and the bolt.

8. The synchronously adjustable pivot according to claim 7, wherein one of the washers is made of a material having high coefficient of friction and sandwiched between other washers.

9. The synchronously adjustable pivot according to claim 1, wherein the outer receiving seat further has a plurality of corresponding side plates, and a fixing bolt penetrates through the plurality of side plates.

10. The synchronously adjustable pivot according to claim 1, wherein a gasket is provided between the outer sleeve and the inner receiving seat.

11. The synchronously adjustable pivot according to claim 1, wherein the inner surface of the inner sleeve is formed into a conical shape.

12. A synchronously adjustable pivot connected between an inner receiving seat and an outer receiving seat, comprising:
an outer sleeve with its interior hollowed;
a knob accommodated in the outer sleeve, one end thereof having a screw rod;
an inner sleeve accommodated in the outer sleeve, the inner sleeve being hollow and an inner surface thereof having threads for threadedly connecting to the screw rod;
a fixing seat provided at the outside of one end of the outer receiving seat, penetrating through the outer receiving seat and the inner receiving seat and connected with one end of the outer sleeve, the axial center of the fixing seat provided with a through hole for facing the screw rod of the knob; and
a bolt provided at the outside of the other end of the outer receiving seat, penetrating the outer receiving seat and the inner receiving seat and connected with the other end of the outer sleeve.

13. The synchronously adjustable pivot according to claim 12, wherein the inner receiving seat and the outer receiving seat are each formed into a U-shaped body.

14. The synchronously adjustable pivot according to claim 12, wherein the end face of the screw rod further has a locking hole thereon.

15. The synchronously adjustable pivot according to claim 14, wherein the locking hole is formed into a hexagon.

16. The synchronously adjustable pivot according to claim 12, wherein the inner surface of the inner sleeve is formed into a conical shape.
